(19) United States
(12) Patent Application Publication
(10) Pub. No.: US 2005/0101310 A1
(43) Pub. Date: May 12, 2005

(54) Real time system update in a mobile communication network

(75) Inventor: Amit Shachak, Petah-Tiqwa (IL)

Correspondence Address: F. JASON FAR-HADIAN;CENTURY IP LAW GROUP, Suite 1815, 222 Figueroa Street, Los Angeles, CA, 90012-2601, US

(73) Assignee: IXI Mobile (R&D) Ltd.

(21) Appl. No.: 10/706,173

(22) Filed: Nov. 12, 2003

(51) Int. Cl. H04M 3/00

(52) U.S. Cl. 455/418; 455/414.2

(57) ABSTRACT

A system for updating database records associated with configuration data stored in at least one mobile device is provided. The system comprises a comparator for determining if the configuration data has been modified; and a transmitter for transmitting the configuration data to a server system for updating respective records of a database, in response to the configuration data being modified in the mobile device.

### BACKGROUND

1. Field of Invention

The present invention relates generally to mobile communication services and, more particularly, to a system and method for automatically updating configuration data for a service subscriber in a mobile communications network.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Mobile communication technology and communication related services continue to grown at a rapid pace. Since the advent of mobile communication networks and mobile communication devices, such as cellular telephones, customer service and technical support has been an important issue for the service providers. Due to the sheer increase in the number of mobile subscribers, the variety of mobile devices used by the subscribers, and the seemingly endless options and configurations available for each mobile device, providing customer and technical support has become more costly and challenging.

Most service providers require that a mobile device to be configured for use by way of programming the mobile device. To program a mobile device, certain configuration data is burned or stored in the mobile device's memory. Such data includes, for example, an access point name (APN), a web gateway internet protocol (IP) address, a short messaging service center (SMSC), system identification code (SID), and other system or environment dependent codes.

The configuration data is essential for successfully providing the needed services to a subscriber. For example, an APN is the name of the server that provides data services; and the SID is a unique 5-digit number that is assigned to each carrier by the FCC. This and other system and environment related data are used by the communications network systems and the mobile device to identify, process and route communication signals. Any change or mistake in storing said data in the mobile device can result in an interruption in service or improper operation of the mobile device.

Accordingly, it is important for a service provider and customer service representatives to be able to quickly determine if configuration data has been corrupted, erased or accidentally modified. Unfortunately, currently, when a subscribe encounters a problem with his service or mobile device, the customer service providers rely on the subscriber to provide such information. This is because a telephone or on-line based customer service representative does not have direct access to data stored on a mobile device that has become problematic to the subscriber.

Typically, when a subscriber encounters a problem with his or her mobile device, the subscriber will call the customer support center for assistance. Depending on the nature of the problem, a customer service representative may ask the subscriber to follow a certain procedure to access the configuration data stored on the mobile device. Alternatively, the customer service representative may initiate an access procedure to remotely retrieve the configuration data.

The above procedures are not cost-effective, however, because they are unreliable and call for the mobile device to meet certain requirements (e.g., be turned on, within range, etc.). Furthermore, not all mobile devices can be accessed remotely by the service provider to retrieve configuration data. And, this remote access procedure is, at times, even more time consuming than directly requesting the needed information from the subscriber.

Depending on the mobile device and the subscriber's sensibility and level of understanding, asking or guiding a subscriber to access the configuration information stored in the device can be a tedious task. Following the proper configuration menus and related steps in each menu are often times confusing to subscribers that have a technical background, let alone the less savvy ones.

As such, some customer service sessions that require trouble-shooting can be rather lengthy and often unsuccessful, if the subscriber cannot correctly identify or access the configuration data, particularly if the remote access procedure fails or is not available. Without the knowledge of such data, a customer service representative cannot determine if the mobile device is correctly configured. Hence, the subscriber problems cannot be solved in a timely fashion.

Even when the subscriber is ready and able to provide the configuration data or when the remote access procedure is available, a customer service representative may have to guide the subscriber to change or store new data in the mobile device's memory. This also requires a level of technical dexterity, which a subscriber may lack. Therefore, it is understandable that both the subscriber and the customer service representative will experience some frustration, if access to and modification of the configuration data is not readily possible.

For the above reasons, a method and system that can provide a service provider and its representatives with real time access to configuration data stored on a mobile device are needed. Such system and method will dramatically increase the efficiency of customer support centers. Time and energy saved in providing technical support will improve customer relations and reduce the operating cost of providing customer care.

### SUMMARY

One or more embodiments of the present invention is directed to a system and corresponding methods that facilitate real time update of database records associated with configuration information stored in one or more mobile devices. In certain time intervals a mobile device transmits the configuration information stored in its memory to the service provider. The service provider depending on a certain set of conditions may update database records associated with said configuration information.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In accordance with one aspect of the invention, a method for updating database records associated with configuration data stored in at least one mobile device is provided. The method comprises determining if the configuration data has been modified; and transmitting the configuration data to a server system for updating respective records of a database, in response to the configuration data being modified in the mobile device.

The method may further comprise transmitting the configuration data to the server system in real time. In some embodiments configuration data is transmitted to the server system within a predetermined time period, if it is determined that the configuration data is modified in the mobile device. At least one record of the database is updated based on information contained in the configuration data. The configuration data is compared with the respective records of the database.

The configuration data is transmitted to the server system, if it is determined that the configuration data is different from that stored in the respective records of the databases. In certain embodiments it is determined if configuration data transmitted to the server is invalid. The configuration data is automatically corrected, if the configuration data is invalid. Further in some embodiments, an alert is generated if the configuration data is invalid.

In accordance with one aspect of the invention, the configuration data comprises at least one of an access point name (APN), a web gateway internet protocol (IP) address, a short messaging service center (SMSC), system identification code (SID), system dependent information, and communication environment dependent information.

According to another embodiment, a system for updating database records associated with configuration data stored in at least one mobile device is provided. The system comprises a comparator for determining if the configuration data has been modified; and a transmitter for transmitting the configuration data to a server system for updating respective records of a database, in response to the configuration data being modified in the mobile device.

The transmitter transmits the configuration data to the server system in real time. In certain embodiments, the transmitter transmits the configuration data to the server system within a predetermined time period, if it is determined that the configuration data is modified in the mobile device.

The system may further comprise means for updating at least one record of the database based on information contained in the configuration data, and means for comparing the configuration data with the respective records of the database. The transmitter transmits the configuration data to the server system, if it is determined that the configuration data is different from that stored in the respective records of the databases.

In one embodiment, the system also comprises means for determining if configuration data transmitted to the server is invalid, and means for automatically correcting the configuration data, if the configuration data is invalid. In one or more embodiments, the system also comprises means for generating an alert, if the configuration data is invalid.

In accordance with another embodiment, a computer readable medium comprising logic code configured for processing by a microcontroller is provided. Execution of the logic code causes a computing system to determine if the configuration data has been modified, and transmit the configuration data to a server system for updating respective records of a database, in response to the configuration data being modified in the mobile device.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment in accordance with one or more embodiments of the invention;

FIG. 2 is a flow diagram of a real time method for updating configuration data in a communications network, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide an automatic real time update system for configuration information stored in a communications network database.

The terms electronic services, services, and online services are used interchangeably herein. The services provided by the system of this invention, in one or more embodiments, are provided by a service provider. A service provider is an entity that operates and maintains the computing systems and environment, such as server systems and infrastructure that enable the delivery of information and services. Typically, server architecture comprises of components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

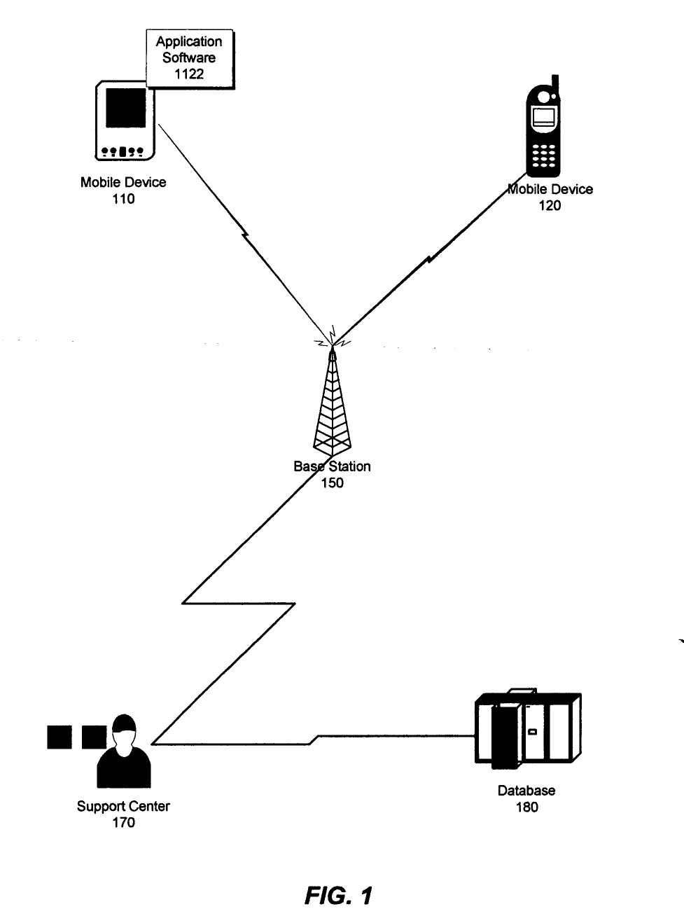

Referring to the drawings, FIG. 1 illustrates an exemplary communications environment in which the system of the present invention may operate. In accordance with one aspect of the system, the environment comprises plurality of mobile devices 110, 120 that communicate with a support center 170, for example.

Support center 170 is connected to a database 180, for example, to update and store, among other information, configuration data received from mobile devices 110, 120. The terms “connected,” “coupled,” or any variant thereof, mean any connection or coupling, either direct or indirect, between two or more elements. The coupling or connection between the elements can be physical, logical, or a combination thereof.

In one embodiment, service provider (not shown) communicates with mobile devices 110, 120 connected in the communications network illustrated in FIG. 1. The communications network provides the medium and infrastructure (i.e., base station 150) for transmitting digital or analog signals between the service provider and mobile devices 110, 120. In certain embodiments, mobile devices 110, 120 are cellular telephones, and the communications network is a cellular telephone network, for example. Mobile devices 110, 120, the service provider and the communications network, however, may be implemented over any type of mobile, fixed, wired or wireless communication system.

One of ordinary skill in the art will appreciate that the communications network may advantageously be comprised of one or a combination of various types of networks without departing from the scope of the invention. For example, in some embodiments, the communications network can comprise local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications network or part of the world wide web (i.e., the Internet).

In either context, mobile devices 110, 120 can communicate with a service provider to send and receive electronic packets of information, in form of electronic requests and responses. In one embodiment, the service provider is a wireless communications service provider (e.g., Sprint, AT&T or Verizon) to which a user may subscribe.

Some of the services provided by the system of the present invention may be implemented as application software installed and executed on mobile devices 110, 120, as provided in further detail below. In certain embodiments, the application software executed on mobile devices 110, 120 can act as client software that is in communication with a server of the support center 170 or the service provider, for example.

Alternatively, in some embodiments, mobile devices 110, 120 may comprise a PMG device or communicate with a PMG device. The PMG architecture comprises a PMG server that can wirelessly communicate with a number of PMG enabled devices within the personal area of the user, thus providing a personal area network (PAN).

In addition, the PMG server can wirelessly communicate with remote server systems, such as a service provider or support center 170, via a wireless system or communications network in a WAN. Thus, the PMG acts as an interface to seamlessly connect a PAN to a WAN, and as such the devices attached to the PAN or WAN can communicate with each other. A more detailed description of the PMG architecture is provided in U.S. patent application Ser. No. 09/850,399, filed on May 7, 2001, the entire content of which is hereby incorporated by reference here.

As used herein, the terms service provider, support center and communications network are to be viewed as designations of one or more computing environments that comprise application, client or server software for servicing requests submitted by respective software included in mobile devices or other computing systems connected thereto. These terms are not to be otherwise limiting in any manner. The application software 1122, for example, may be comprised of one or more modules that execute on one or more computing systems, as provided in further detail below.

Application Software for Real Time Update of Configuration Data

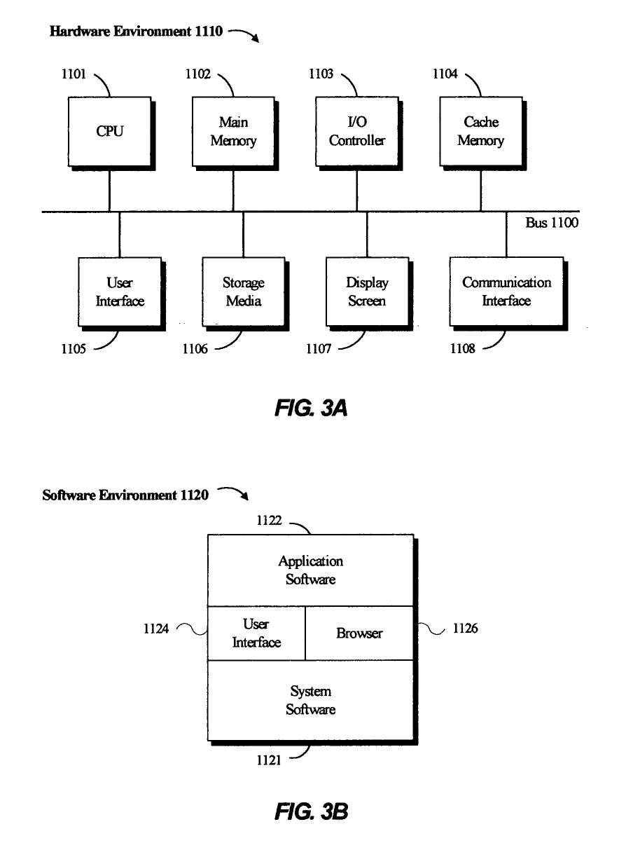

Referring to FIGS. 1 and 3A, in accordance with one aspect of the invention, application software 1122 is implemented on mobile device 110, for example, to provide real time updates to support center 170 (or the service provider) about the configuration data stored on mobile device 110. In other embodiments, application software 1122 is capable of communicating with a third party system, such as a database 180, or a PMG device to perform the update procedure. The application software 1122, in some embodiments, may receive instructions from the support center 170 to generate and send an update to support center 170 or database 180, so that the subscribers' records are updated accordingly.

It should be noted, however, that the exemplary embodiments disclosed above are not to be construed to limit the scope of the invention to application software that is exclusively executed on mobile device 110, or a system that exclusively operates to provide real time support to update mobile device configuration data. Other data may be also updated based on the technology that is the subject matter of this invention.

In some embodiments, application software 1122 may be implemented on a device or system other than mobile device 110. For example, application software 1122 or its components may be implemented, installed, and executed either in a singular or in a distributed environment. Certain components of the application software 1122 may be installed and executed on mobile devices 110, 120 while other components may be executed and installed on, for example, a PMG device, support center 170, internet portals, service provider server systems, or other computer systems and networks attached thereto.

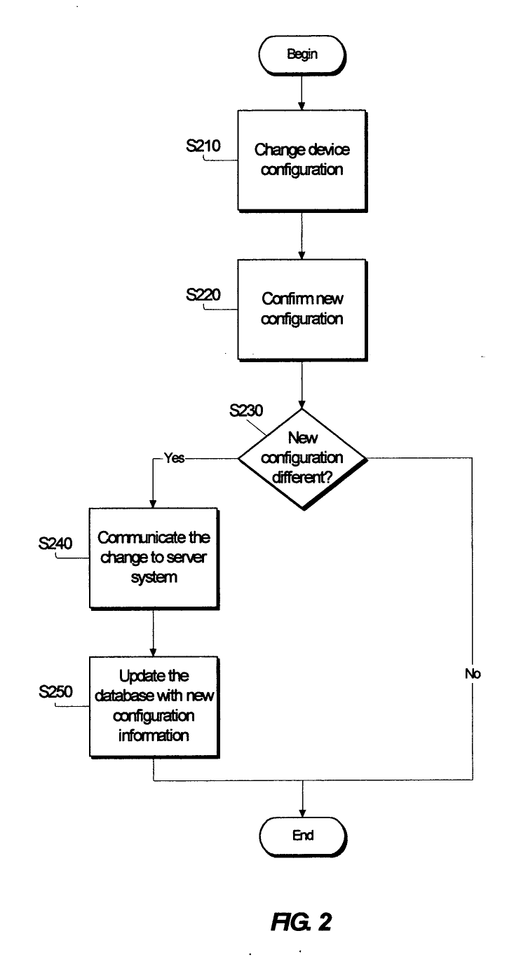

Referring to FIGS. 1 and 2, in accordance with one aspect of the invention, when a subscriber activates a mobile device 110 to use the services provided by the service provider, certain configuration data are programmed or stored in the phone's memory during the activation process. The configuration data comprises a variety of information related to processing, routing and timing of communication data between mobile device 110 and base station 150. Accordingly, changing the configuration data modifies mobile device 110's configuration.

Referring to FIG. 2, a subscriber may change mobile device 110's configuration (S210) by interacting with the mobile device 110's user interface, for example, to modify the configuration data. The user interface, in certain embodiments, provides menus that guide the subscriber to change the settings on the phone by pressing keys on the keypad and entering the requested configuration data. In some embodiments, once the data is entered, the subscriber will be prompted to confirm the newly entered configuration (S220). This confirmation process advantageously serves to prevent accidental changes to the phone configuration.

In some embodiments, application software 1122 operates to determine whether the new configuration is different from the old configuration stored in mobile device 110's memory (S230). If so, application software 1122 causes mobile device 110 to communicate the change to a server system (not shown) connected to support center 170 and/or database 180 (S240). As such, in certain embodiments, the new configuration data is transmitted from mobile device 110 to the service provider in order to update database 180 records (S250).

Database 180 comprises a plurality of records and data structures that are implemented in relationship with one another to track and reference configuration data for each service subscriber and mobile device 110. Accordingly, based on the above implemented update procedure, a support center 170 representative can in real time determine the configuration settings of mobile device 110 by referring to data stored in database 180.

Various update procedures may be implemented in accordance to one or more embodiments. For example, in one embodiment, the update procedure takes place immediately after mobile device 110 is reconfigured, by way of mobile device 110 transmitting the new configuration data to the service provider.

In other embodiments, the new configuration data is transmitted after a predetermined time period has lapsed, either in response to a request submitted by the service provider or in the event of expiration of a default time period. The time laps can help save processing time, if configuration data is updated too frequently, for example, due to user error or device malfunction.

In one embodiment, application software 1122, or other software in communication therewith, performs a verification process to determine that the new configuration data is legitimate before it is stored in the database 180. Accordingly, the configuration data is compared to a range of values. If it is determined that the configuration data is out of range, then an alert signal or message is produced to notify the subscriber, for example. In such scenario, the subscribe may be given the option to reenter the data or restore the system settings to its default or previous value.

In certain circumstances, application software 1122 is implemented to detect a corruption in configuration data and automatically correct the corruption. Since the system update procedure is performed in real time, an alert signal is provided to support center 170 or a technical support representative. Based on the alert and also the update configuration data stored in database 180, a customer service representative can make a decision on how to solve the problem associated with the corruption.

In some embodiments, the system may automatically or in conjunction with a human operator restore the appropriate values in mobile device 110, by way of remote signal transmission. Thus, configuration data for mobile device 110 can be updated, verified, and reset either automatically or manually in accordance with one or more methods provided herein.

It is noteworthy that configuration data may comprise not only information that may be utilized for setting system features, but also other user related information (e.g., ring tones, display color, contact information, calendar items, and other user data or preferences) that are stored on the mobile device 110. As such, depending on implementation, the configuration data stored in database 180 may be used (with user's permission) to determine a subscriber profile for research or marketing purposes.

In embodiments of the system, mobile devices, service provider servers, support centers and databases comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task such as detecting changes in configuration data stored in mobile device 110 and reporting the updated data to the service provider.

Referring to FIG. 3A, an embodiment of the application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a blue tooth port, a modem, or an integrated services digital network (ISDN) card, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless mobile device (e.g., cellular phone), or other similar hardware platforms that have information processing and/or data storage and communication capabilities. For example, in one or more embodiments of the system, hardware environment 1110 may comprise a PMG unit or an equivalent thereof.

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software, such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows CE, Microsoft Windows NT, Macintosh OS, or IBM OS/2. However, any other suitable operating system may be utilized.

Application software 1122 can comprise one or more computer programs that are executed on top of system software 1121 after being loaded from storage media 1106 into memory 1102. In client-server architecture, application software 1122 may comprise client software and server software. Referring to FIG. 1 for example, in one embodiment of the invention, client software is executed on mobile unit 110 and server software is executed on the service provider system (not shown) or support center 170.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate updating configuration data of a mobile device stored in a service provider's database. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of updating database records associated with configuration data stored in at least one mobile device, the method comprising:
determining if the configuration data has been modified; and
transmitting the configuration data to a server system for updating respective records of a database, in response to the configuration data being modified in the mobile device.

2. The method of claim 1, further comprising:
transmitting the configuration data to the server system in real time.

3. The method of claim 1, further comprising:
transmitting the configuration data to the server system within a predetermined time period, if it is determined that the configuration data is modified in the mobile device.

4. The method of claim 1, further comprising:
updating at least one record of the database based on information contained in the configuration data.

5. The method of claim 1, further comprising:
comparing the configuration data with the respective records of the database.

6. The method of claim 5, further comprising:
transmitting the configuration data to the server system, if it is determined that the configuration data is different from that stored in the respective records of the databases.

7. The method of claim 1, further comprising:
determining if configuration data transmitted to the server is invalid.

8. The method of claim 7, further comprising:
automatically correcting the configuration data, if the configuration data is invalid.

9. The method of claim 7, further comprising:
generating an alert, if the configuration data is invalid.

10. The method of claim 1, wherein the configuration data comprises at least one of an access point name (APN), a web gateway internet protocol (IP) address, a short messaging service center (SMSC), system identification code (SID), system dependent information, and communication environment dependent information.

11. A system for updating database records associated with configuration data stored in at least one mobile device, the system comprising:
a comparator for determining if the configuration data has been modified; and
a transmitter for transmitting the configuration data to a server system for updating respective records of a database, in response to the configuration data being modified in the mobile device.

12. The system of claim 11, wherein the transmitter transmits the configuration data to the server system in real time.

13. The system of claim 11, wherein the transmitter transmits the configuration data to the server system within a predetermined time period, if it is determined that the configuration data is modified in the mobile device.

14. The system of claim 11, further comprising:
means for updating at least one record of the database based on information contained in the configuration data.

15. The system of claim 11, further comprising:
means for comparing the configuration data with the respective records of the database.

16. The system of claim 15, wherein the transmitter transmits the configuration data to the server system, if it is determined that the configuration data is different from that stored in the respective records of the databases.

17. The system of claim 11, further comprising:
means for determining if configuration data transmitted to the server is invalid.

18. The system of claim 17, further comprising:
means for automatically correcting the configuration data, if the configuration data is invalid.

19. The system of claim 17, further comprising:
means for generating an alert, if the configuration data is invalid.

20. The system of claim 11, wherein the configuration data comprises at least one of an access point name (APN), a web gateway internet protocol (IP) address, a short messaging service center (SMSC), system identification code (SID), system dependent information, and communication environment dependent information.
